(19) United States
(12) Patent Application Publication
(10) Pub. No.: US 2018/0257917 A1
(43) Pub. Date: Sep. 13, 2018

(54) Winch with Internal Battery in Bag

(71) Applicants: David R. Hall, Provo, UT (US); Daniel Madsen, Vineyard, UT (US); Benjamin Taylor, Provo, UT (US)

(72) Inventors: David R. Hall, Provo, UT (US); Daniel Madsen, Vineyard, UT (US); Benjamin Taylor, Provo, UT (US)

(21) Appl. No.: 15/451,843

(22) Filed: Mar. 7, 2017

(51) Int. Cl. B66D 3/00; B66D 1/12; B66D 1/22; B66D 1/38

(52) U.S. Cl. CPC B66D 3/006; B66D 1/12; B66D 2700/0191; B66D 1/38; B66D 2700/0141; B66D 1/22

(57) ABSTRACT

The invention is a mobile winch in a bag system. A motorized winch with an internal battery is mounted on a metal plate that is attached the bottom inner portion of a bag. The metal plate may have attachment points for coupling an anchor component to fix the winch in position during a winching operation. The mobile winch in a bag system provides a way to transport and operate a winch in areas that are otherwise inaccessible by traditional vehicle-mounted winches without the necessity of separately transporting the components of the system and with reduced setup of the components for use.

### TECHNICAL FIELD

This invention relates generally to the field of hoists, winches, and other pulling and/or lifting devices, and more specifically to mobile winch systems.

### BACKGROUND

Hoists and winches are devices that are used extensively in lifting, lowering, or pulling loads of various kinds. A winch, in particular, is a mechanical device used for lifting or pulling that typically includes a line, such as a cable or chain, wrapped around a drum, which may be manually rotated or driven with a motor, such as an electrical, hydraulic, or pneumatic motor. Typically, one end of the line is secured to the drum while the free end of the line includes a hook or other hook-like device. When the motor turns in one direction, the line can be fed outwardly, and when the motor turns in the opposite direction, the line is pulled inwardly, creating a pulling force on the line and hook. Some winches may include braking mechanisms to prevent the rotation of the drum, or guides or other mechanisms to evenly wind the line around the drum.

A winch may be used beneficially in situations where a pulling force on an item is required. The winch must, however, be transportable to the necessary location, yet fixed in a location with respect to the item to be pulled. Consequently, winches are often fixed to vehicles. For example, one end of the line may be attached to an object to hoist or haul, and the other end of the line is wound around a drum mounted on a vehicle. However, while the winch mounted to a vehicle has some advantages, the disadvantage is that the winch is permanently coupled to the vehicle, and the winch can only be used in conjunction with the vehicle, or where the vehicle may maneuver. While a person could theoretically transport a winch separately to a location where a vehicle mounted winch cannot go, current winch designs have numerous necessary components that must be transported to the location, assembled, used, and then disassembled, which presents a significant inconvenience. Furthermore, some winches are bulky or cumbersome, and even if all of the components were transported in some sort of enclosure, the components would still require removal and setup for use.

In light of the foregoing, what is needed is a convenient, portable winch that can be operated in areas inaccessible by vehicles, but without requiring the inconvenience of separately transporting and setting up various winch components. Such a winch should also have an independent power source that does not rely on a vehicle battery. Current designs have met this need by depositing a winch and a battery source in a bag, mounted to a metal plate within the bag. However, such designs could be further improved upon by depositing the power source within the drum of the winch. This would allow for a smaller winch system, providing even greater convenience in transporting and manufacturing the winch-bag system, and it would allow for a simpler assembly.

### SUMMARY OF THE INVENTION

The disclosed invention has been developed in response to the present state of the art and, in particular, in response to the problems and needs in the art that have not yet been fully solved by currently available components and methods. Accordingly, efficient structural components and methods have been developed to allow for a winch with an internal battery made mobile by a bag.

Consistent with the foregoing, an apparatus is disclosed. The apparatus comprises a bag having an opening that includes a closure means, the closure means allowing the opening in the bag to be in an open or enclosed position. The apparatus also comprises a metal plated affixed to a bottom surface on an inner portion of the bag, a winch mounted to the metal plate, and an anchor component for anchoring the apparatus in a generally fixed position, the anchor component being removably attached to the metal plate. The winch comprises a motor, a winch drum, a winch cable attached to and wound about the winch drum, and a battery that drives the motor. The battery is disposed within the winch drum. The winch cable also has a free end.

In some embodiments, the winch further comprises a controller, which may be disposed within the winch drum. The controller may comprise a wireless module, such as a Bluetooth module in communication with a mobile electronic device. The winch may also comprise a cable guide system, an electrical connector that can be plugged into for fully powering the winch or recharging the battery, and/or at least two gearboxes for shifting gears within the winch. The winch's motor may be a brushless motor, and the battery may be located adjacent to the motor, preferably between the motor and the controller. The bag may comprise handles and/or a slit on a side of the bag for the free end of the winch cable to pass through. The free end of the winch cable may comprise a hook for securing the winch cable to an object. The anchor component may comprise a strap removably attached to the metal plate, which may comprise one or more attachment points, by means of a removable fastener. A corresponding method is also disclosed and claimed herein.

### BRIEF DESCRIPTION OF THE DRAWINGS

A more particular description of the invention briefly described above is made below by reference to specific embodiments depicted in drawings included with this application, in which:

FIG. 1A depicts an exterior view of one embodiment of a winch;

FIG. 1B depicts an interior exploded view of one embodiment of a winch;

FIG. 2 depicts a top view of one embodiment of the invented apparatus generally comprising a winch in a bag;

FIG. 3 depicts a front view of one embodiment of the invented apparatus (as in prior art);

FIG. 4 depicts a back view of one embodiment of the invented apparatus (as in prior art);

FIG. 5 depicts a cross-sectional view of one embodiment of the invented apparatus; and

FIG. 6 depicts one embodiment of the invented apparatus in use during a winching operation, in accordance with one aspect of the present invention (as in prior art).

### DETAILED DESCRIPTION

A detailed description of the claimed invention is provided below by example, with reference to embodiments in the appended figures. Those of skill in the art will recognize that the components of the invention as described by example in the figures below could be arranged and designed in a wide variety of different configurations. Thus, the detailed description of the embodiments in the figures is merely representative of embodiments of the invention, and is not intended to limit the scope of the invention as claimed.

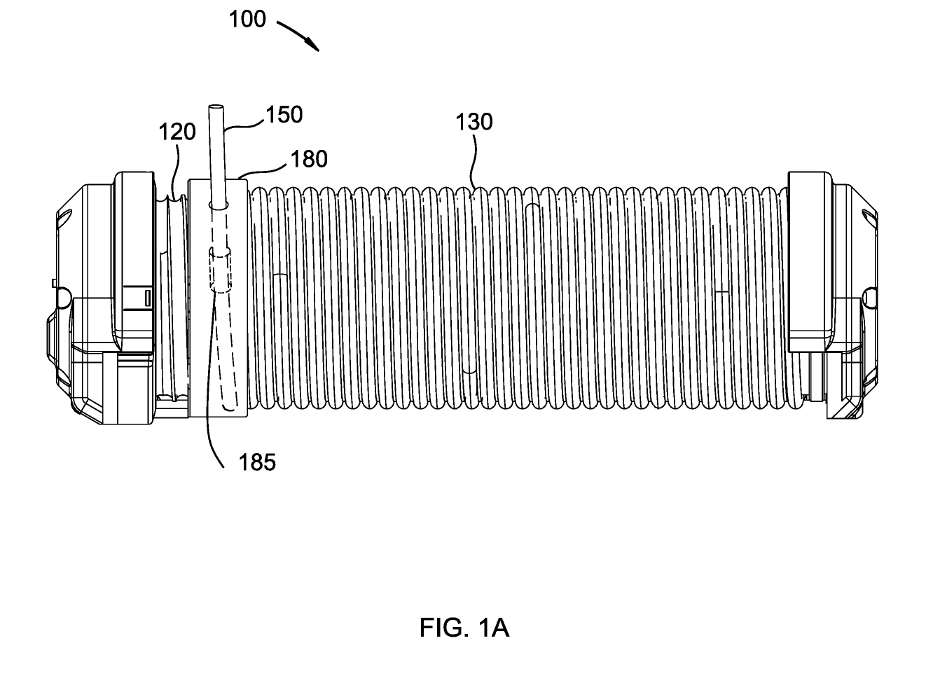

FIG. 1A and FIG. 1B depict views of one embodiment of a winch 100. FIG. 1A depicts an exterior view. FIG. 1B depicts an interior exploded view. The winch 100 comprises a motor 110, a winch drum 120, and a winch cable 130 attached to and wound about the winch drum 120. The winch cable 130 has a free end 150. The motor 110 drives the winch drum 120 in either direction, as desired by a user. The winch cable 130 is wound about the winch drum 120 such that rotation of the winch drum 120 by the motor 110 either retracts or extends the winch cable 130. The winch 100 further comprises a battery 140 that drives the motor 110. The battery 140 is disposed within the winch drum 120. The motor 110 is electrically coupled to the battery 140. In one embodiment, the motor 110 is a brushless motor, preferably a 12-volt DC brushless motor. Because this motor can run on a relatively small amperage, a smaller-than-usual battery can be used to power the motor, such that the battery 140 can fit inside the winch drum 120. In one embodiment, the motor 110 is also disposed within the winch drum 120. In one embodiment, the battery 140 is located adjacent to the motor 110 within the winch drum 120. In one embodiment, the winch 100 further comprises an electrical connector 160 that can be plugged into for fully powering the winch 100 or for recharging the battery 140. In one embodiment, the battery 140 may not be removed from the winch 100, but it can be recharged by means of the electrical connector 160. The electrical connector 160 may be an XT60 hobby connector or a similar connector. A cable may be plugged into the electrical connector 160 and into an electrical power source, such as a vehicle battery or a standard wall outlet, thus providing power to recharge the battery 140 or fully power the winch 100.

In one embodiment, the winch 100 further comprises a controller 170. In one embodiment, the controller 170 is operatively connected to the winch 100 for controlling operation of the winch 100. For example, the controller 170 may be exterior to the winch 100, but connected by a cable. In this embodiment, the controller 170 may be operated by a switch, which may be physically or remotely attached to the controller 170. In another embodiment, the controller 170 is disposed within the winch drum 120. The controller 170 may be a microcontroller on a printed circuit board (PCB) wired to the motor 110 within the winch drum 120. In one embodiment, the controller 170 comprises a wireless module 175, preferably a Bluetooth module. In one embodiment, the wireless module 175 is in communication with a mobile electronic device. In this embodiment, a user can communicate with the controller 170 by means of the wireless module 175 through a mobile electronic device to operate the winch 100. In one embodiment, the battery 140 is located between the controller 170 and the motor 110 within the winch drum 120. In one embodiment, the controller 170, which may comprise a wireless module 175 is located on an outer edge of the winch 100 so that the wireless module 175 can transmit and receive signals more freely, being enclosed by fewer materials. In one embodiment, the winch 100 further comprises a cable guide system 180, which helps to distribute the winch cable 130 evenly around the winch drum 120. In one embodiment, the winch 100 further comprises a winch cable wiper assembly 185, which cleans the winch cable 130 as it winds around the winch drum 120, reducing the likelihood that dirt, mud, debris, or other materials accumulate within the winch 100. The winch cable wiper assembly 185 may be integrated into the cable guide system 180. In one embodiment, the winch cable wiper assembly 185 comprises bristles or brushes. In other embodiments, the winch cable wiper assembly 185 comprises compressional wiper devices, such as clamps, or other cleaning devices. In one embodiment, the winch 100 further comprises at least two gearboxes 190 within the winch drum 120. The presence of at least two gearboxes 190 allows a user to switch gears, such that lighter loads can be pulled at a faster rate. The ability to switch gears also allows for a smaller motor 110, which requires a smaller battery 140, allowing the battery 140 to be disposed within the winch drum 120, preferably between the controller 170 and the motor 110. In one embodiment, the winch 100 also comprises an anti-back drive mechanism 195, which allows a user to lock the winch cable 130 into one direction of rotation so that it cannot wind or unwind unintentionally.

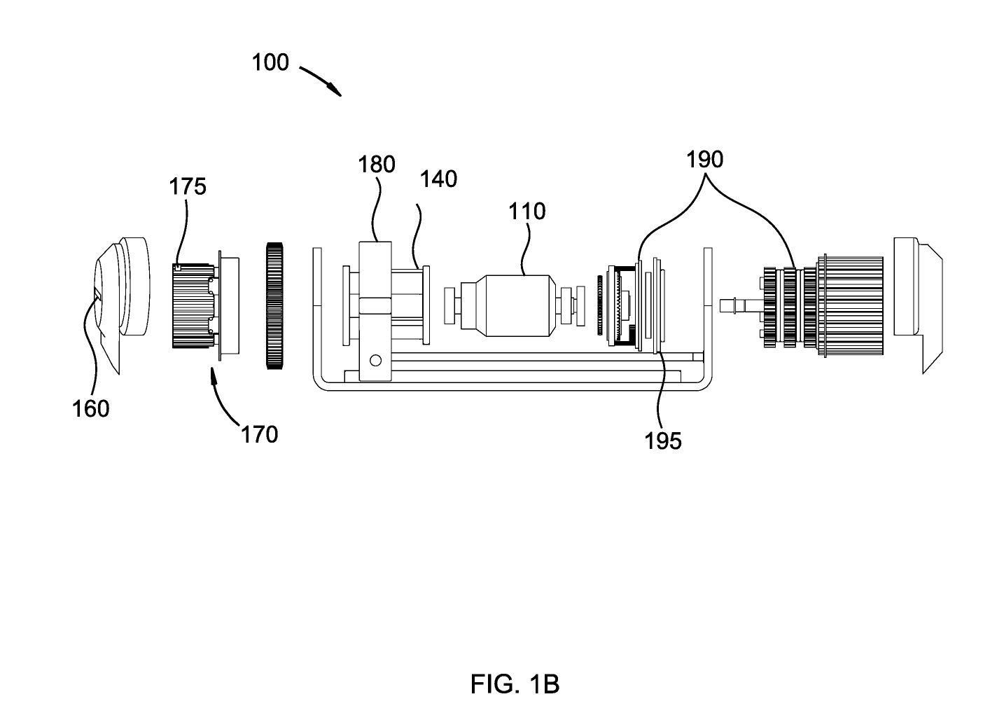

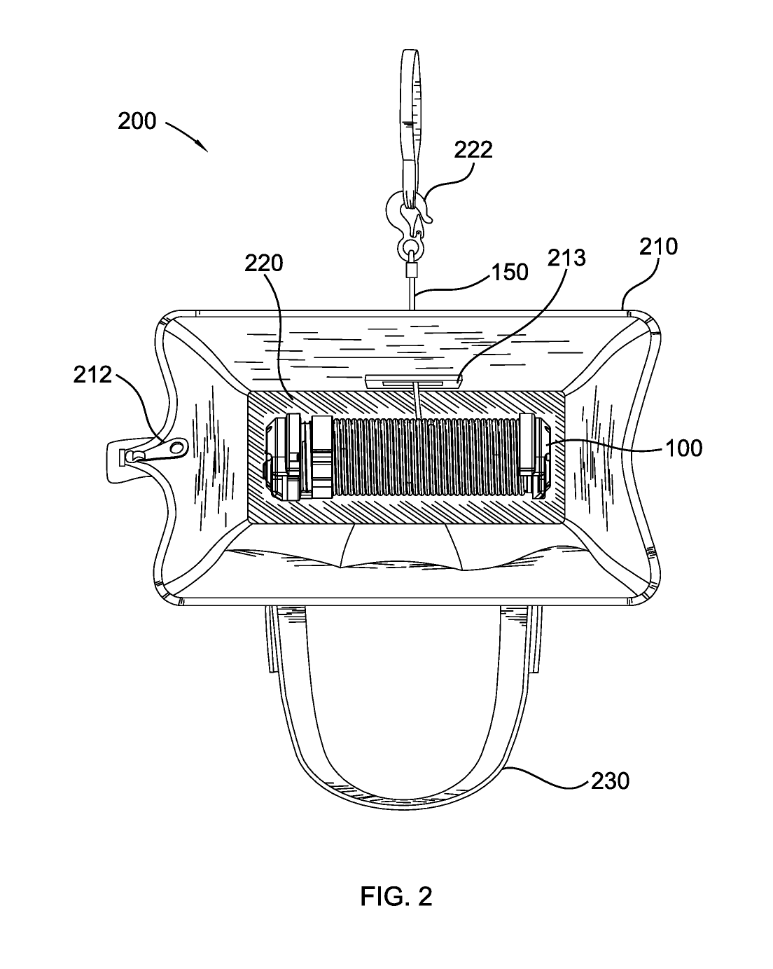

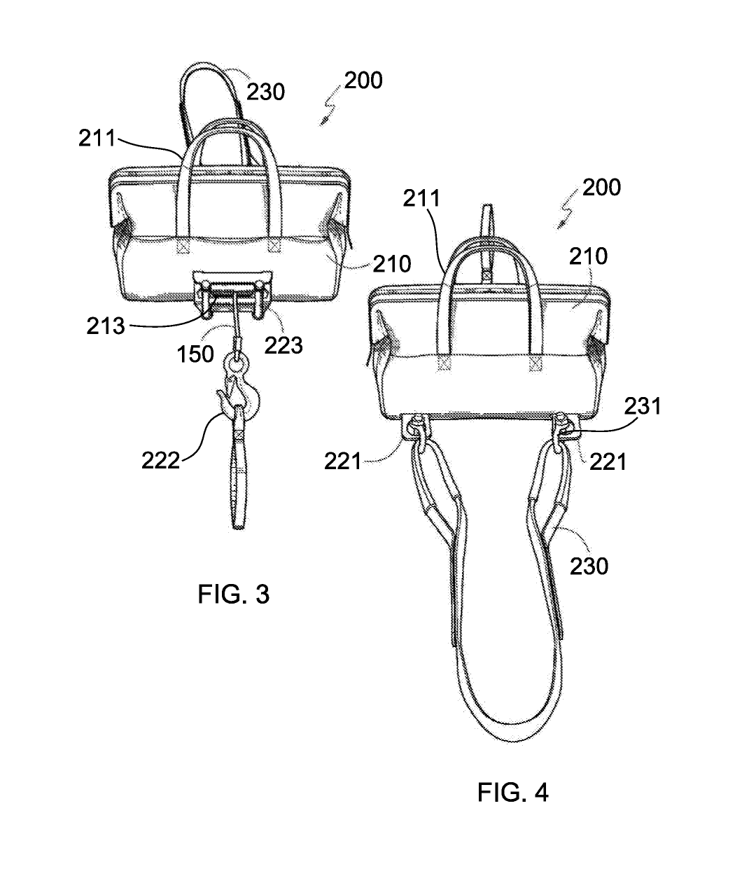

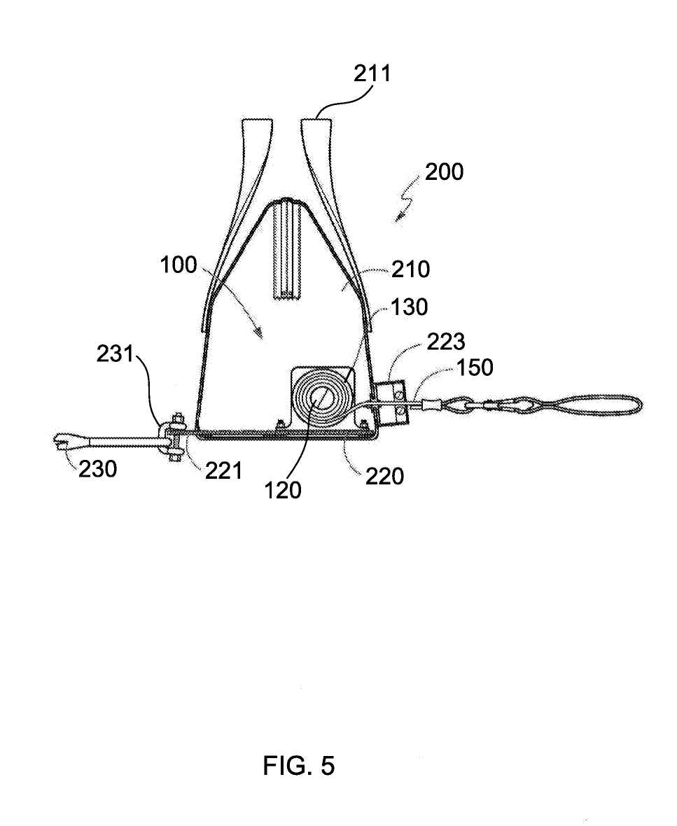

FIGS. 2-5 depict views of one embodiment of an apparatus 200 generally comprising a winch 100 in a bag 210. Specifically, the apparatus 200 comprises a bag 210, a metal plate 220, a winch 100, and an anchor component 230. FIG. 2 depicts a top view. FIG. 3 depicts a front view. FIG. 4 depicts a back view. FIG. 5 depicts a cross-sectional view.

The bag 210 of the apparatus 200 has an opening that includes a closure means, which allows the opening in the bag 210 to be in an open or enclosed position. A single person can easily move the bag 210 to any physical location required by simply lifting and transporting the bag 210. To aid in transport, the bag 210 may have one or more handles 211, wheels, straps, or other useful items. The bag 210 may also have zippers 212, buttons, or other features to aid in enclosing and securing the winch 100 within the bag 210. In one embodiment, the bag 210 comprises a slit 213 on a side of the bag 210 closest to the winch 100 so that the winch cable 130 can be pulled through the side of the bag 210. The slit 213 on the side of the bag 210 allows the winch 100 to be utilized without removal of the winch 100 or the metal plate 220 that the winch 100 is mounted to from the bag 210.

The metal plate 220 is affixed to a bottom surface on an inner portion of the bag 210. In one embodiment, the metal plate 220 is a generally rectangular-shaped metal plate. In one embodiment, the metal plate 220 has attachment points 221 that protrude through incisions in the bag 210 and extend outside the bag 210. The metal plate 220 acts as a rigid base for the winch 100. The winch 100 is mounted to the metal plate 220 inside the bag 210. The winch 100 may be mounted to the metal plate 220 with bolts or the like. The winch 100 comprises a motor 110, a winch drum 120, a winch cable 130 attached to and wound about the winch drum 120, and a battery 140 that drives the motor 110. The battery 140 is disposed within the winch drum 120. The winch cable 130 has a free end 150. In one embodiment, the winch drum 120 faces in an opposite direction from the attachment points 221 on the metal plate 220 such that the free end 150 of the winch cable 130 may be pulled or extended in an outward direction relatively straight away from the winch 100 and attachment points 221. In one embodiment, the free end 150 of winch cable 130 comprises a hook 222 attached thereto for securing the winch cable 130 to an object to be winched in any suitable manner. When not in use, the free end 150 of the winch cable 130 may be pulled inside of the bag 210 to prevent uncontrolled movement of the winch cable 130. In one embodiment, the winch 100 comprises a cable guide system 180. In one embodiment, a fairlead 223 is attached to the bag 210 or to the metal plate 220, over the slit 213 in the side of the bag 210 from which the winch cable 130 exits, in order to preserve the life of the winch cable 130 by reducing the friction of winching operations, particularly between the slit 213 in the side of the bag 210 and the winch cable 130.

The anchor component 230 of the apparatus 200 is for anchoring the apparatus 200 in a generally fixed position. The anchor component 230 is removably attached to the metal plate 220. In one embodiment, the anchor component 230 is removably attached to the metal plate 220 by means of a removable fastener 231. In one embodiment, the anchor component 230 is removably affixed to each lateral edge of the metal plate 220 at the attachment points 221. In one embodiment, the attachment points 221 protrude from the bag 210 to allow for the attachment of the anchor component 230 to the apparatus 200 in order to anchor the apparatus 200 in a fixed position. The anchor component 230 may be removably affixed to the metal plate 220 at the attachment points 221 through the use of a clevis fastener and cotter pin. In one embodiment, the attachment points 221 are heavy duty metal rings welded to the metal plate 220. In another embodiment, the attachment points 221 are holes defined by metal strips extending from the metal plate 220 and either welded, bolted in place, integrally formed with the metal plate, or affixed in any suitable manner, wherein a removable fastener 231, preferably a clevis fastener, may be removably attached to the holes defined by the metal strips. In one embodiment, the anchor component 230 comprises a strap. In one embodiment, the anchor component 230 comprises a tree trunk protector strap made of tough, high quality nylon. Other embodiments may utilize other suitable removable anchor components 230 for anchoring the apparatus 200 in a generally fixed position. In one embodiment, one end of the anchor component 230 is released from the attachment points 221, allowing the anchor component 230 to be wrapped around a fixed object and re-attached to the attachment points 221. In one embodiment, the anchor component 230 may be stored and transported within the bag 210 when not in use.

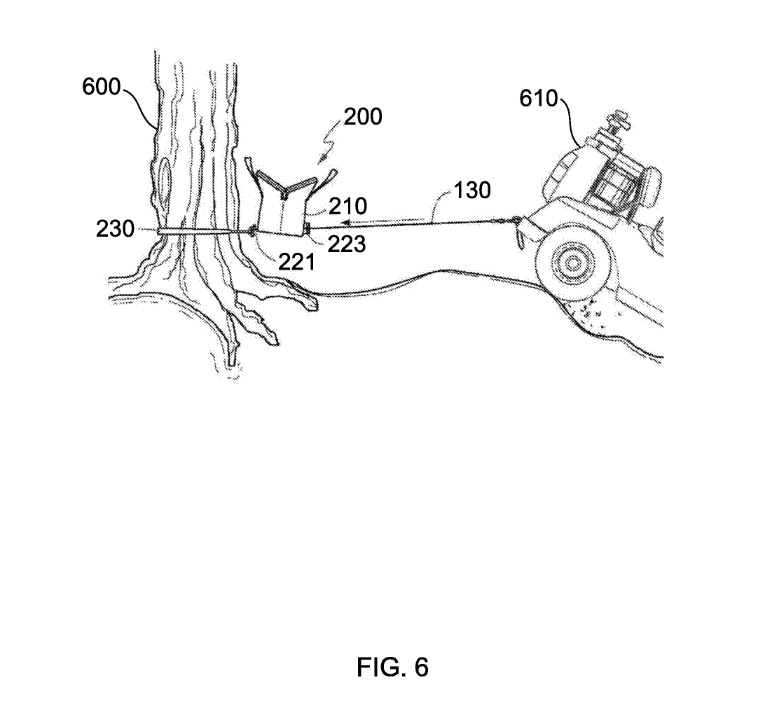

FIG. 6 depicts one embodiment of the apparatus 200 as it may be used in operation. The method of operation comprises providing a bag 210 defining a slit 213 for a winch cable 130 to pass through, a metal plate 220 attached to an inner portion of the bag 210, a winch 100 attached to said metal plate 220, and an anchor component 230 for anchoring the winch 100 in a fixed position to prevent movement during operation. The winch 100 comprises a winch drum 120 driven by a motor 110, a winch cable 130 wound about the winch drum 120, and a battery 140 that drives the motor 110. The battery 140 is disposed within the winch drum 120. The bag 210 is transported to a desired location and oriented so that the slit 213 faces a target object 610 to be winched. The winch 100 is anchored at the desired location. A free end 150 of the winch cable 130 is extended to the target object 610 and attached to the target object 610. The winch drum 120 is rotated to retract the winch cable 130 such that the winching operation exerts a pulling force on the target object 610, while the winch 100 is positioned inside of the bag 210. The apparatus 200 may be manually transported by carrying of the bag 210 to a desired location. An important aspect of this invention is the ability to transport the apparatus 200 over terrain and to locations inaccessible by current vehicle-mounted winches. During a winching operation, the anchor component 230 may be secured to a fixed object 600, such as a tree or stump, and the winch cable 130 may be extended outwardly and attached to the target object 610 to be winched, as shown in FIG. 6. During the winching operation, it is noted that the apparatus 200 may be raised from the ground as the winch cable 130 tightens. This placement depends upon the position and orientation of the free end 150 of the winch cable 130 and the anchor component 230. It is contemplated that the winch cable 130 may also be directed upwardly, toward the top of a tree that is being cut, for instance, and then the force exerted by the winch 100 would be at a downward angle toward the winch 100. In most cases, it will be necessary to use the anchor component 230 to prevent the winch 100 from moving, because otherwise, the winching operation is likely to simply move the winch 100 toward the target object 610, rather than moving the target object 610 toward the winch 100.

1. An apparatus comprising:
a bag having an opening that includes a closure means, the closure means allowing the opening in the bag to be in an open or enclosed position;
a metal plate affixed to a bottom surface on an inner portion of the bag;
a winch mounted to the metal plate, the winch comprising a motor; a winch drum; a winch cable attached to and wound about the winch drum, the winch cable also having a free end; and a battery that drives the motor, the battery disposed within the winch drum; and
an anchor component for anchoring the apparatus in a generally fixed position, the anchor component being removably attached to the metal plate.

2. The apparatus of claim 1, wherein the winch further comprises a controller.

3. The apparatus of claim 2, wherein the controller is disposed within the winch drum.

4. The apparatus of claim 2, wherein the controller is operatively connected to the winch for controlling operation of the winch.

5. The apparatus of claim 2, wherein the controller comprises a wireless module.

6. The apparatus of claim 5, wherein the wireless module is a Bluetooth module.

7. The apparatus of claim 5, wherein the wireless module is in communication with a mobile electronic device.

8. The apparatus of claim 2, wherein the battery is located between the controller and the motor within the winch drum.

9. The apparatus of claim 1, wherein the battery is located adjacent to the motor within the winch drum.

10. The apparatus of claim 1, wherein the winch further comprises an electrical connector that can be plugged into for fully powering the winch or recharging the battery.

11. The apparatus of claim 1, wherein the motor is a brushless motor.

12. The apparatus of claim 1, wherein the winch further comprises a cable guide system.

13. The apparatus of claim 1, wherein the bag comprises a slit on a side of the bag for the free end of the winch cable to pass through.

14. The apparatus of claim 1, wherein the anchor component comprises a strap.

15. The apparatus of claim 1, wherein the anchor component is removably attached to the metal plate by means of a removable fastener.

16. The apparatus of claim 1, wherein the metal plate comprises one or more attachment points for securing the anchor component thereto.

17. The apparatus of claim 1, further comprising a hook attached to the free end of the winch cable to secure the winch cable to an object.

18. The apparatus of claim 1, the winch comprising at least two gearboxes within the winch drum.

19. The apparatus of claim 1, wherein the winch further comprises a winch cable wiper assembly.

20. A method comprising:
providing a bag defining a slit for a winch cable to pass through;
providing a metal plate attached to an inner portion of said bag;
providing a winch attached to said metal plate, wherein said winch comprises a motor, a winch drum driven by said motor, a winch cable wound about said winch drum, and a battery that drives said motor, the battery disposed within the winch drum, and wherein the rotation of said winch drum either retracts or extends said winch cable;
providing an anchor component for anchoring said winch in a fixed position to prevent movement during operation;
transporting said bag containing said winch to a desired location for winching operation;
orienting said bag so said slit faces an object to be winched;
anchoring said winch at said desired location to prevent substantial movement of said winch during winching operation;
extending a free end of said winch cable to a target object;
attaching said winch cable to said target object; and
rotating said winch drum to retract said winch cable such that said winching operation exerts a pulling force on said target object, while said winch is positioned inside of said bag.
